(19) United States
(12) Patent Application Publication
(10) Pub. No.: US 2010/0000051 A1
(43) Pub. Date: Jan. 7, 2010

(54) CASEMENT WINDOW HINGE WITH INTEGRATED ARM PIVOTS

(76) Inventor: Jack C. La See, Abbotsford, WI (US)

Correspondence Address: BOYLE FREDRICKSON S.C., 840 North Plankinton Avenue, MILWAUKEE, WI, 53203, US

(21) Appl. No.: 12/166,448

(22) Filed: Jul. 2, 2008

(51) Int. Cl. E05D 7/00

(52) U.S. Cl. 16/364

(57) ABSTRACT

A casement window hinge eliminates the use of rivets in the pivot between the sash arm and guide arm such as require a high force deformation of an element to a precise compression that varies according to a “tolerance stack up” between four controlled dimensions of the parts being assembled: the length of the rivet, the deformation of the rivet head, and the thickness of the two arms being assembled. The invention eliminates two of these dimensions through the use of integrally molded pivot pins that fit into a bore in the second arm and which are plastically flanged. Resistance to a pull-out of wood screws that are countersunk into a plastic sash arm is provided by exaggerated counter sinking with undersized countersink bores.

### CROSS-REFERENCE TO RELATED APPLICATIONS

—

### STATEMENT REGARDING FEDERALLY SPONSORED RESEARCH OR DEVELOPMENT

—

### BACKGROUND OF THE INVENTION

The present invention relates to casement window hinges and in particular to a casement window hinge with a sash arm and guide arm providing improved manufacture.

Casement window hinges allow a window to open by pivoting about a vertical axis that moves inward as the window opens. This combination motion is provided by special casement window hinges supporting the window sash. A separate operator moves the window as mounted on the hinges, typically through the use of a crank mechanism.

Casement window hinges typically employ a two-bar linkage of a sash arm and guide arm. The sash arm is attached along the window sash, for example, by countersunk wood screws directed up through the sash arm into the wood of the sash. An inward end of the sash arm is pivotally attached to a slide that may move along a track attached to the window opening and that defines the movable pivot point of the window. A center of the sash arm is pivotally attached to one end of a guide arm whose remaining end of the guide arm is pivotally attached to the track displaced from the slide.

The sash arm and guide arm can be subject to large forces, for example, during shipping, installation, or when the window is subject to wind loads. For this reason, the sash arm and guide arms are typically fabricated out of a sturdy metal such as stainless steel. They are connected together, typically, by a metal rivet that is lightly staked to allow the parts to pivot. Normally the slide is also riveted to the sash arm.

For smooth and reliable operation, it is important that the rivets between the sash arm, guide arm and slide be tight to prevent excess play between these parts that may cause premature wear or “hammering” in the joints under wind load. On the other hand the rivets must not be so tight as to promote excess friction making the window hard to open or close. While riveting is a simple operation when a joint must be tightly fastened, controlling the large forces required to properly stake the rivets to provide just the right compression for a pivoting joint is extremely difficult. Tolerance “stack up” in the variations of the length of the rivet, the deformation of its head during the staking process, and in the thickness of the two pieces being assembled, makes it difficult to ensure low play in the pivot as well as low friction.

### BRIEF SUMMARY OF THE INVENTION

The present invention provides an improved casement window hinge that employs plastic pivot pins connecting between plastic sash and guide arms. The pivot pins may be thermally staked after insertion through a corresponding hole to eliminate play in the pivoting joint. Friction that can prevent the joint from moving, as can occur with the compression incident to metallic rivets, is avoided in the present invention by the natural lubricity of the plastic-to-plastic interface and/or the staking process that does not produce substantial compressive forces. In a preferred embodiment, the pivot pins are integrally molded into one or both of a plastic sash arm or guide arm further eliminating play caused by looseness between the pivot pins and sash or guide arm.

The inventor has further determined that the problems of countersunk wood screws pulling through a plastic sash arm can be solved by substantially decreasing the size of the countersink thus significantly increasing the contact area between the screw head and the plastic sash arm over the length of the countersink. Mismatch between the shaft size of the wooden screw and the small bore size, such as would be a problem in a metal sash arm, is avoided in a plastic sash arm where the much harder wood screw may slightly enlarge the countersink bore in the plastic sash arm during installation. Finally, the problem of excessive torques being placed on a sash-arm stop (needed to limit opening of the window) are solved by use of a hinging slide stop that permits assembly of the slide into its track but, by moving the stop along the sash arm to the slide, reduces destructive torques on the stop.

Specifically then, the invention provides a casement window hinge having a longitudinally extending track attachable to a window opening, a slide retainable by the track for movement therealong, a sash arm pivotally attached to the slide at an inner end attachable to a window sash, and a guide arm pivotally attached at one end to the track and at the other end to the sash arm. The sash arm and a guide arm are constructed of a moldable thermoplastic and are joined by a pivot pin passing through a hole formed in one of the sash arm and guide arm, where the pivot pin is constructed of a moldable thermoplastic material having at least one flange to retain the sash arm and guide arm attached together in a pivoting relationship.

It is thus one feature of one embodiment of the invention to provide an improved pivot for casement hinges that eliminates play that can result in damaging joint forces while naturally limiting joint friction.

The pivot pin may be integrally molded with the one sash arm and guide arm.

It is thus another feature of the invention to provide even further reduced joint play by forming the pivot pin integrally with one of the sash and guide arms.

The flange may be thermally formed to be larger than would reversibly pass through the hole.

It is thus an aspect of one embodiment of the invention to provide a staking method that provides near zero joint play with limited joint compression. Because the thermal staking essentially melts the end of the pivot pin, the flange may abut the pivoting arm with near zero clearance and yet without the compressive forces normally part of a staking process deforming a metal rivet.

The casement window hinge may further including a pivot between the slide and the sash arm including a second pivot pin passing through a hole formed in one of the sash arm and slide, the second pivot pin constructed of a moldable thermoplastic material having at least one flange to retain the sash arm and slide attached together in a pivoting relationship.

It is thus another aspect of one embodiment of the invention to provide similar benefits for the connection of the sash arm and slide.

The sash arm may include a plurality of holes having frustro-conical counter sinks in which a larger base of the frustum has a radius substantially twice the radius of that of the smaller base.

It is thus a feature of one embodiment of the invention to permit the use of thermoplastic materials for the construction of the sash arm and guide arm. By decreasing the countersink bore radius, the total conical area contacted by the screw head is increased by a square of the radius decrease, providing a disproportionate increase in pullout strength. Tolerance problems from this reduced countersink bore size can be accommodated by the ability of the thermoplastic material to flow under pressure from a countersink screw. Use of plastic sash and guide arms allows integral formation of the plastic pivot pins and a desirable plastic-on-plastic pivot pin interface.

The slide may include an extension abutting a stop affixed to the track when the sash arm is perpendicular to the track.

It is thus an aspect of the invention to displace torsional forces from the pivot between the sash arm and the guide arm allowing both to be practically molded of plastic.

The extension may include a live hinge allowing it to be displaced from the stop for removal of the slide.

It is thus an aspect of the invention to allow simplified assembly of the hinge with a stop on the slide that automatically assumes a stop function once assembled.

A pivot between the guide arm and the track may have a boss constructed of a moldable thermoplastic material and attached to the track and received in a snap fit with a corresponding bore in the guide arm.

It is thus another feature of one embodiment of the invention to provide for a plastic-to-plastic interface in connecting the guide arm to what is typically a metallic track.

The boss may be eccentrically mounted for rotation with respect to the track.

It is thus another feature of one embodiment of the invention to allow for correction of sagging in the hinge by changing the effective length of the guide arm.

The boss may rest on a tubular extension from the track receiving a screw fitting into the tubular extension.

It is thus another feature of one embodiment of the invention to provide a well-registered metallic attachment point for the guide arm.

The snap fit may be provided by an interfitting ridge and groove formed at a circumferential interface between the boss and corresponding bore.

It is thus a benefit of one embodiment of the invention that it provides simple field attachment of the guide arm to the track without removing the boss.

An exposed face of the boss may include a slot for receiving a screwdriver for rotation of the boss.

It is thus a benefit of one embodiment of the invention to allow simple adjustment of sash sag by the consumer.

These particular features and advantages may apply to only some embodiments falling within the claims and thus do not define the scope of the invention.

### BRIEF DESCRIPTION OF THE DRAWINGS

FIG. 1 is a top plan view of the casement window hinge of the present invention showing the sash arm, guide arm, slide and track structures common to hinges of this type;

FIG. 2 is a perspective view of the slide of FIG. 1 showing an extension with a living hinge providing a stop for the window at full opening;

FIG. 3 is a cross-sectional view through lines 3-3 of FIG. 1 showing a thermally formed flange on a pivot pin attaching the sash arm to the slide, the flange received within a counter bore in a slide to remain recessed within the slide;

FIG. 4 is a fragmentary perspective view of a pivot mechanism connecting the guide arm to the track showing an eccentric mechanism for adjusting the effective guide arm length;

FIG. 5 is a cross-section through lines 5-5 of FIG. 4 showing assembly of the eccentric mechanism to a coined post on the track;

FIG. 6a is a phantom view of a prior art countersunk bore in the sash arm;

FIG. 6b is a figure similar to that of FIG. 6a showing a bore with extended surface area providing increased pullout resistance to wood screws;

FIG. 7 is a front elevational view in partial cross-section of the track and slide of the present invention showing a flared track channel permitting alignment of the slide with the track for shorter windows;

FIG. 8 is a figure similar to FIG. 7 in side elevation, showing a chamfer on the slide permitting alignment of the slide and the track for longer windows; and

FIG. 9 is a fragmentary perspective view of the extension of FIG. 2 and corresponding stop formed in the slide.

### DETAILED DESCRIPTION OF THE INVENTION

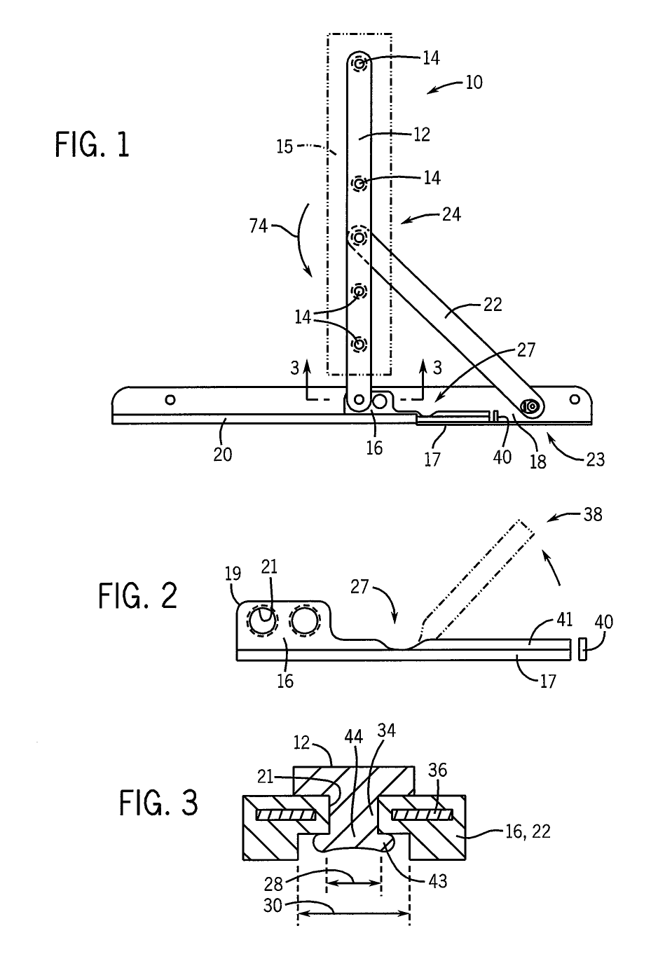

Referring now to FIG. 1, a casement window hinge 10 may include a sash arm 12 that may be attached to a window sash 15 by means of mounting holes 14 receiving countersunk head wood screws (not shown in FIG. 1) upward through the sash arm 12 therethrough. A proximal end of the sash arm 12 is pivotally attached to a slide 16 that may move along a length of a metal track 18 as retained by a rolled flange 20 in the metal track 18.

A proximal end of a guide arm 22 is pivotally attached to the track 18 at an end 23 of the track 18 removed from the travel range of the slide 16, and a distal end of the guide arm 22 is pivotally attached to a midpoint 24 of the sash arm 12. The sash arm 12 and guide arm 22 form a two-bar linkage providing a simultaneous pivoting and translation of an attached window. The general structure of hinges of this type is described in U.S. Pat. No. 6,088,880 to LaSee, assigned to the assignee of the present invention and hereby incorporated by reference.

Referring now also to FIG. 2, the slide 16 includes a leftward extending stop arm 41 whose end may abut a stop 40 formed in the track 18 to prevent the window from opening too far as will be described below.

A rear edge of the slide 16 and stop arm 41 supports an upwardly extending ridge 17 that may be captured under the rolled flange 20 of the track 18. This ridge 17 extends leftward from a slide body 19 to provides a living hinge 27 between the slide body 19 and the stop arm 41 allowing the latter to flex to an assembly position 38 away from the stop 40 so that the slide 16 may be assembled into the track 18 at a portion of the track 18 not having the rolled flange 20. Upon completion of that assembly, the natural elasticity of the living hinge 27 returns the stop arm 41 to the straightened position so that leftward travel of the slide 16 is ultimately blocked by the stop 40.

Referring now to FIG. 3, the slide 16 and distal end of the guide arm 22 include counterbored holes 21 having a principal diameter 28, and a counterbore diameter 30 on their underside larger than principal diameter 28. Corresponding pivot pins 44 on the sash arm 12 may extend downward from the surface of the sash arm 12 to be received within these bores 26. The pivot pins 44 have a cylindrical shaft 34 with a diameter conforming to principal diameter 28 of the bore 26.

An end of the shafts 34 extending through the principal diameter 28 of the bores 26 may be thermally staked to create a flanged head 36 of diameter less than the counterbore diameter 30 and a thickness less than the depth of the counterbore to fit wholly therein, but of diameter greater than the principal diameter 28 of the counterbored holes 21 so as to retain the pivot pin 44 within the counterbored holes 21. The staking process may be performed by a number of thermal staking techniques including ultrasonic or heated plate staking and provides a near zero-tolerance fit between a flanged head 36 and a seat of the counterbored holes 21 with very little compressive force as a result of the melting of the material of the pivot pin 44.

In a second embodiment, the flanged head 36 may be preformed to a diameter allowing a snap fit with the counterbored holes 21. The flanged head 36 may be bored and slotted to assist in its compression during this snap fit.

Ideally the pivot pins 44 are molded to be integral with the thermoplastic sash arm 12, a material choice for the sash arm 12 that is made possible by fabricating the sash arm 12 of a thermoplastic material strengthened, for example, with glass fiber. By constructing both the sash arm 12 and guide arm 22 out of thermoplastic, a plastic-to-plastic interface is formed resisting binding and destructive wear between the pivot pin 44 and the sash arm 12 or guide arm 22.

As will be understood in the art, the slide 16 may also be molded from a thermoplastic material and typically is molded about a steel spine 43 which, in this case, may include a hole amply sized to allow the molding of the counter bored hole 21 into the slide 16.

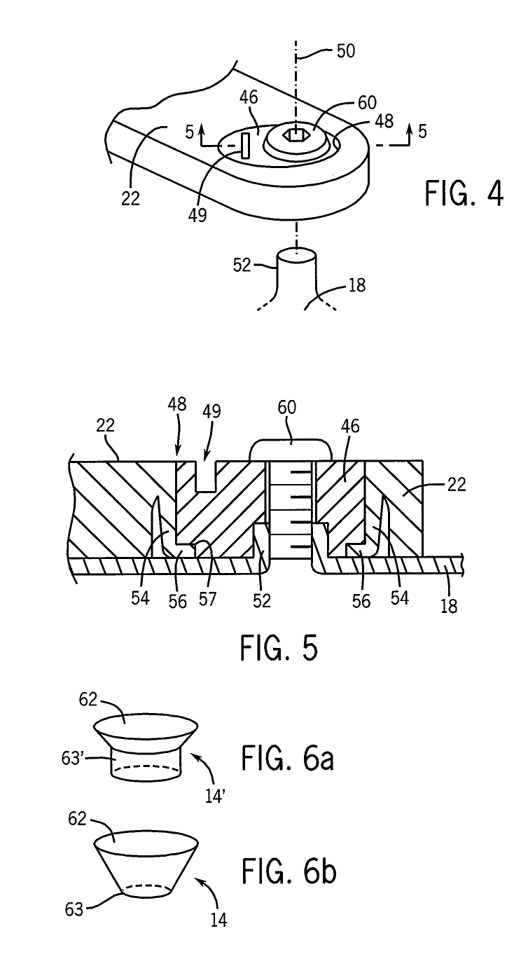

Referring now to FIGS. 1, 4 and 5, the attachment of the proximal end of the guide arm 22 to the track 18 (constructed of sheet metal in the present invention) is obtained through a molded thermoplastic boss 46 attached to the track 18 (as will be described) and snap-fitting into a corresponding bore 48 in the proximal end of the guide arm 22. The boss 46 has a generally cylindrical outer surface and thus may rotate within the guide arm 22 when twisted by a screwdriver inserted into a slot 49 cut in the upper face of the boss 46. The boss 46 provides a rotation axis 50 with respect to its attachment to the track 18 (as will be described) that is eccentric with respect to an outer circumference of the boss 46. Thus, rotation of the boss 46 with respect to the guide arm 22 causes an effective change of the length of the guide arm 22 as may correct for sash sag as described generally in U.S. Pat. Nos. 4,790,106 and 5,017,075, assigned to the same assignee as the present invention and hereby incorporated by reference.

Referring to FIG. 5, the attachment of the boss 46 to the track 18 is provided by means of a coined protrusion in the track 18 providing an upwardly extending, upwardly open tube 52 integrally formed in the track 18. The inside of this open tube 52 may be threaded to receive a pan head, hex drive, machine screw 60 whose head may retain the boss 46 against axial movement with respect to the track 18 while allowing rotational movement of the boss 46 about the machine screw 60

The snap connection between the boss 46 and the guide arm 22 is provided by opposed downwardly cantilevered spring fingers 54 molded into the inner diameter of the bore 48 of the guide arm 22 receiving the boss 46. Teeth 56 at the lower edge of the spring fingers face inward to receive a corresponding outwardly open rim 57 in the lower edge of the boss 46.

Referring now to FIGS. 6a and 6b, in a prior art, hole 14′ receiving countersunk head wood screws to attach the sash arm 12 to a window sash provided an amply-sized countersink bore 63′ cut through the sash arm 12 avoiding interference between a shaft of the wood screw and a too-small bore in a metallic sash arm 12. Limited conical counter sinking 62′ is provided so that the head of the wood screw would be flush with a surface of the sash arm 12 to prevent interference in the opening and closing of the window by a protruding screw head.

In the present invention, the radius of the countersink bore 63 is significantly reduced to equal or be slightly less than the expected diameter of the shaft of a wood screw. This reduction in radius increases the total area of the conical counter sinking 62 as a square of the reduction in radius to provide sufficient pullout resistance in the plastic of the sash arm 12. The conical counter sinking 62 provides a frustro-conical surface having an upper base of greater diameter and a lower base of lesser diameter. In the preferred embodiment, the radius of the upper base is no less than substantially twice the radius of the smaller base. The increased risk of interference between the smaller hole size of the smaller base and the shaft of the wood screw is remedied by the soft characteristic of the plastic material allowing the wood screw to slightly enlarge this hole as needed. The present inventor has determined that this radius reduction provides a sufficient pullout resistance to allow construction of the sash arm 12 from a reinforced plastic material.

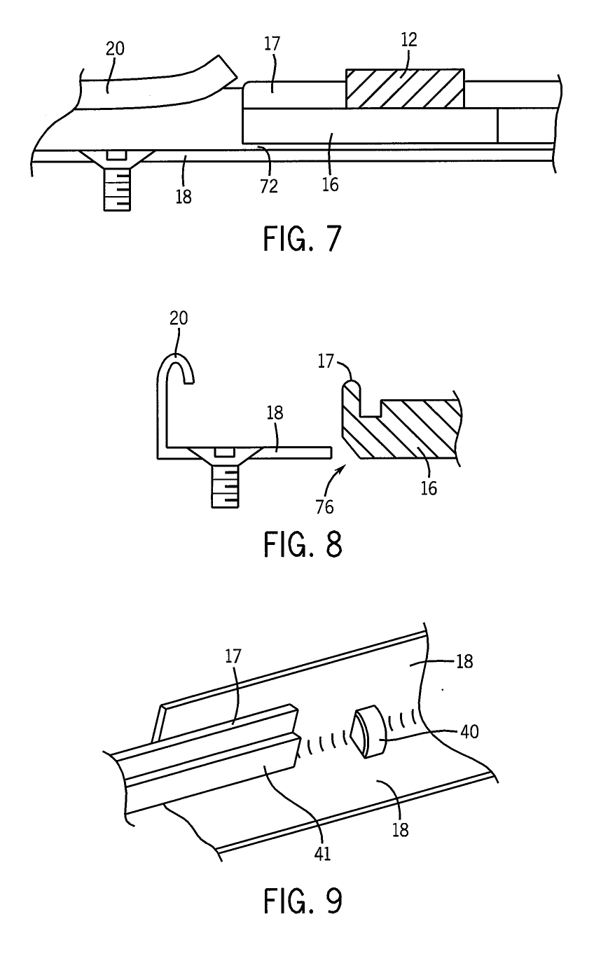

Referring now to FIG. 7, the slide 16 may be pulled upward by an amount 72 when sash arm 12 is attached to a sash (not shown) in a window that is dimensionally shorter than expected. This can make it difficult to insert a guide ridge 17 of the slide 16 under the rolled flange 20. For this reason, the present invention provides for an upward flaring of the rolled flange 20 to provide a funneling of the guide ridge 17 of the slide 16 into the rolled flange 20 when the slide 16 is first assembled onto that track 18. Similarly, as shown in FIG. 8, a rear edge of the slide 16 includes a chamfer 76 so that, in the opposite situation, where the slide 16 is displaced downward when used with a window that is dimensionally taller than expected, the chamfer 76 guides the slide 16 up onto the surface of the track 18.

Referring now to FIGS. 1 and 9, opening of the sash 15 such as would move the sash 15 leftward 74 beyond a perpendicular orientation with respect to the track 18 is stopped by abutment of the stop arm 41 of the slide 16 against the stop 40. This portion of the track 18 near the stop 40 does not have a rolled flange 20 allowing the stop arm 41 to be flexed by means of a living hinge 27 away from the stop 40 for disassembly.

The present invention has been described in terms of the preferred embodiment, and it is recognized that equivalents, alternatives, and modifications, aside from those expressly stated, are possible and within the scope of the appending claims.

We claim:

1. A casement window hinge comprising:
a longitudinally extending track attachable to a window opening;
a slide retainable by the track for movement therealong;
a sash arm pivotally attached to the slide at an inner end attachable to a window sash;
a guide arm pivotally attached at one end to the track and at the other end to the sash arm; and
wherein the sash arm and a guide arm are constructed of a moldable thermoplastic material and are joined by a first pivot pin passing through a hole formed in one of the sash arm and guide arm, the first pivot pin constructed of a moldable thermoplastic material having at least one flange to retain the sash arm and guide arm attached together in a pivoting relationship.

2. The casement window hinge of claim 1 wherein the first pivot pin is integrally molded with one of the sash arm and guide arm.

3. The casement window hinge of claim 1 wherein the flange is thermally formed to be larger than would reversibly pass through the hole.

4. The casement window hinge of claim 1 further including a pivot between the slide and the sash arm including a second pivot pin passing through a hole formed in one of the sash arm and slide, the second pivot pin constructed of a moldable thermoplastic material having at least one flange to retain the sash arm and slide attached together in a pivoting relationship.

5. The casement window hinge of claim 4 wherein the second pivot pin is integrally molded with one of the sash arm and slide.

6. The casement window hinge of claim 4 wherein the flange is thermally formed to be larger than would reversibly pass through the hole.

7. The casement window hinge of claim 4 wherein the first and second pivot pins are integrally formed in the sash arm.

8. The casement window hinge of claim 1 further including a plurality of holes in the sash arm having frustro-conical countersinks in which a larger base of a frustum of the countersinks has a radius substantially twice the radius of that of a smaller base.

9. The casement window hinge of claim 1 wherein the slide includes an extension abutting a stop affixed to the track when the sash arm is perpendicular to the track.

10. The casement window hinge of claim 9 wherein the extension includes a live hinge allowing it to be displaced from the stop for removal of the slide.

11. The casement window hinge of claim 1 further including a pivot between the guide arm and the track comprising a boss constructed of a moldable thermoplastic material and attached to the track and received in a snap fit with a corresponding bore in the guide arm.

12. The casement window hinge of claim 11 wherein the boss is eccentrically mounted for rotation with respect to the track.

13. The casement window hinge of claim 11 wherein the boss rests on a tubular extension from the track receiving a screw threaded into the tubular extension.

14. The casement window hinge of claim 11 wherein the snap fit is provided by an interfitting ridge and groove formed at a circumferential interface between the boss and corresponding bore.

15. The casement window hinge of claim 11 wherein an exposed face of the boss includes a slot for receiving a screwdriver for rotation of the boss.

16. A method of manufacturing a casement window hinge of a type including:
a longitudinally extending track attachable to a window opening;
a slide retainable by the track for movement therealong;
a sash arm pivotally attached to the slide at an inner end attachable to a window sash;
a guide arm pivotally attached at one end to the track and at the other end to the sash arm, the method comprising the steps of:
(a) pivotally joining the sash arm, guide arm, and slide by thermoplastic pivot pins integrally molded in at least one of the sash arm, guide arm and slide, the pivot pins passing through corresponding holes formed in one of the sash arm, guide arm and slide; and
(b) thermally forming flanges on ends of the pivot pins extending through the holes to retain the sash arm, guide arm, and slide attached together in a pivoting relationship.
